(19) United States
(12) Patent Application Publication
(10) Pub. No.: US 2026/0099737 A1
(43) Pub. Date: Apr. 9, 2026

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Kota Watanabe, Kawasaki Kanagawa (JP); Yuto Yamaji, Kawasaki Kanagawa (JP); Hiroo Saito, Kawasaki Kanagawa (JP); Yushiro Kashimoto, Yokohama Kanagawa (JP); Daisuke Kobayashi, Kokubunji Tokyo (JP)

(73) Assignee: KABUSHIKI KAISHA TOSHIBA, Tokyo (JP)

(21) Appl. No.: 19/284,780

(22) Filed: Jul. 30, 2025

(30) Foreign Application Priority Data
Oct. 4, 2024 (JP) 2024-174847

(51) Int. Cl. G06N 5/045; G06V 10/62; G06V 10/74

(52) U.S. Cl. CPC G06N 5/045; G06V 10/62; G06V 10/761

(57) ABSTRACT

An information processing device according to an embodiment includes a hardware processor connected to a memory. The processor receives an input of input information including recognition target data. The processor executes one or more recognition tasks. Each of the recognition tasks is a task of recognizing the recognition target data based on reference information including reference data, one or more pieces of attention region information indicating an entire or a partial attention region of the reference data, and explanatory information about the attention region. The processor outputs information including recognition result obtained by executing the one or more recognition tasks.

### CROSS-REFERENCE TO RELATED APPLICATIONS

This application is based upon and claims the benefit of priority from Japanese Patent Application No. 2024-174847, filed on Oct. 4, 2024; the entire contents of which are incorporated herein by reference.

### FIELD

Embodiments described herein relate generally to an information processing device, an information processing method, and a computer program product.

### BACKGROUND

In a conventional system for recognizing target data based on reference data, a plurality of attention regions of the reference data is used.

For example, the recognition target data is recognized by extracting a feature and comparing the feature with a partial region of the recognition target data for each attention region of the reference data.

However, in the related art, it is difficult to improve the recognition accuracy of the recognition target data.

### BRIEF DESCRIPTION OF THE DRAWINGS

FIG. 1 is a diagram illustrating an example of a functional configuration of an information processing device according to the first embodiment;

FIG. 2 is a diagram illustrating an example of a data configuration of a reference information set according to the first embodiment;

FIG. 3 is a diagram illustrating a specific example of a reference information set according to the first embodiment;

FIG. 4 is a flowchart illustrating a processing example of an extraction unit according to the first embodiment;

FIG. 5 is a flowchart illustrating a processing example of a recognition target image according to the first embodiment;

FIG. 6 is a diagram illustrating a display example of output information according to the first embodiment;

FIG. 7 is a diagram illustrating an example of a functional configuration of an information processing device according to the second embodiment;

FIG. 8 is a diagram illustrating an example of a functional configuration of an information processing device according to the third embodiment;

FIG. 9 is a diagram illustrating an example of a functional configuration of an information processing device according to the fourth embodiment;

FIG. 10 is a diagram illustrating an example of a functional configuration of an information processing device according to the fifth embodiment; and

FIG. 11 is a diagram illustrating an example of a device configuration of an information processing device according to the first to fifth embodiments.

### DETAILED DESCRIPTION

An information processing device according to one embodiment includes a hardware processor connected to a memory. The hardware processor is configured to receive an input of input information including recognition target data. The hardware processor is configured to execute one or more recognition tasks. Each of the recognition tasks is a task of recognizing the recognition target data based on reference information including reference data, one or more pieces of attention region information indicating an entire or a partial attention region of the reference data, and explanatory information about the attention region. The hardware processor is configured to output information including recognition result obtained by executing the one or more recognition tasks.

Hereinafter, embodiments of an information processing device, an information processing method, and a program will be described in detail with reference to the accompanying drawings.

### First embodiment

In the first embodiment, a case where the data format of the recognition target data to be handled is an image will be described as an example. First, an example of a functional configuration of the information processing device according to the first embodiment will be described.

### Example of Functional Configuration

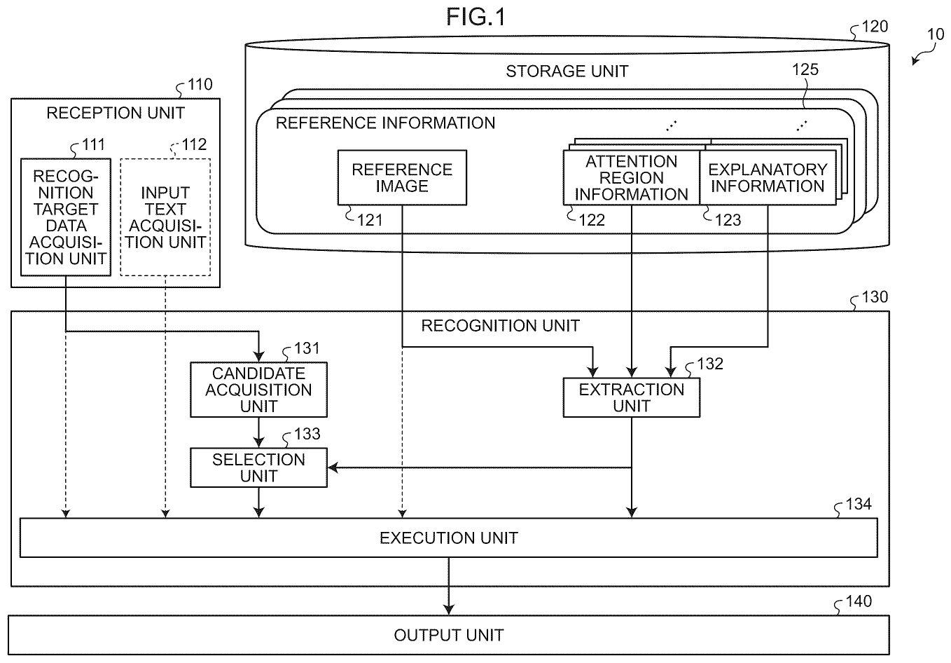

FIG. 1 is a diagram illustrating an example of a functional configuration of an information processing device 10 according to the first embodiment. The information processing device 10 according to the first embodiment includes a reception unit 110, a storage unit 120, a recognition unit 130, and an output unit 140.

The reception unit 110 receives input of input information. The input information is data input to the information processing device 10 by the user, and includes a recognition target image.

The input information may include an input text. The input text is a text input to the information processing device 10 by the user. For example, the input text may include information related to a recognition task executed by an execution unit 134.

Specifically, in a case where plural recognition tasks can be executed, the recognition task to be executed may be designated by the input text. Moreover, for example, in a case where the recognition task generates a response sentence to a user's question on the recognition target image, the input text may be a question sentence indicating the content of the question.

The reception unit 110 includes a recognition target data acquisition unit 111. The reception unit 110 includes an input text acquisition unit 112 when receiving input information further including an input text. Note that, in a case where the input text is not received from the user, the input text acquisition unit 112 may not be included in the information processing device 10.

The recognition target data acquisition unit 111 acquires an image as recognition target data from the input information.

The input text acquisition unit 112 acquires the above-described input text from the input information. Since detailed information about the recognition target data can be given by the input text, more accurate recognition can be performed. In addition, the user can instruct the recognition task to be executed on the recognition target data with the input text, and thereby convenience is improved.

The storage unit 120 stores one or more pieces of reference information 125 (hereinafter, one or more pieces of reference information are collectively referred to as a “reference information set”). The reference information 125 stores a reference image 121, attention region information 122, and explanatory information 123. One or more pairs of the attention region information 122 and the explanatory information 123 (hereinafter, the pair of the attention region information 122 and the explanatory information 123 will be collectively referred to as an “attention region information pair”) are correlated with one reference image 121.

Note that the storage unit 120 is implemented by a nonvolatile memory or another storage device. The storage unit 120 may be included in the information processing device 10 as illustrated in the drawing, or may be implemented by a storage device for storing data on a cloud and provided outside the information processing device 10.

The reference image 121 is an image serving as a reference for recognition of the recognition target image.

The attention region information 122 represents the entire or the partial attention region of the reference image 121. The attention region of the reference image 121 refers to the entire or the partial region that is useful for recognition of the reference image 121. The “region” covers a range of one or more pixels in the reference image 121. The range is represented by any of a rectangle, a polygon, a circle, an ellipse, a point, or a set of a plurality of points.

The explanatory information 123 is information indicating description regarding the attention region information 122. For example, the explanatory information 123 is an optional text describing the attention region indicated by the attention region information 122. The explanatory information 123 may be information about appearance such as a shape, a size, a color, a texture, and a pattern in the attention region. The explanatory information 123 may be information indicating a function, a property, and the like of a target included in the attention region. The explanatory information 123 may be information indicating an appellation, a name, and the like of the attention region.

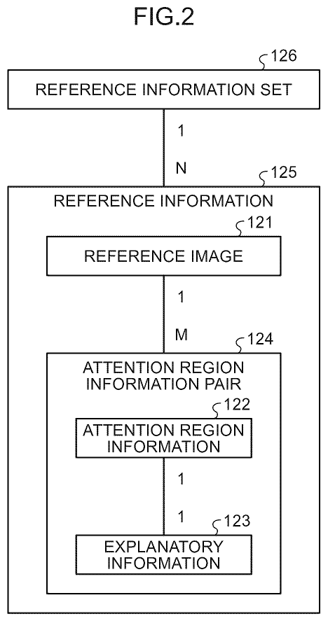

FIG. 2 is a diagram illustrating an example of a data configuration of a reference information set 126 according to the first embodiment. The reference information set 126 includes N pieces of reference information 125 (N is an integer of 1 or more). The reference information 125 includes the reference image 121 and an attention region information pair 124. The reference image 121 is correlated with M attention region information pairs 124 (M is an integer of 1 or more). The attention region information pair 124 includes the attention region information 122 and the explanatory information 123. One piece of explanatory information 123 is correlated with one piece of attention region information 122.

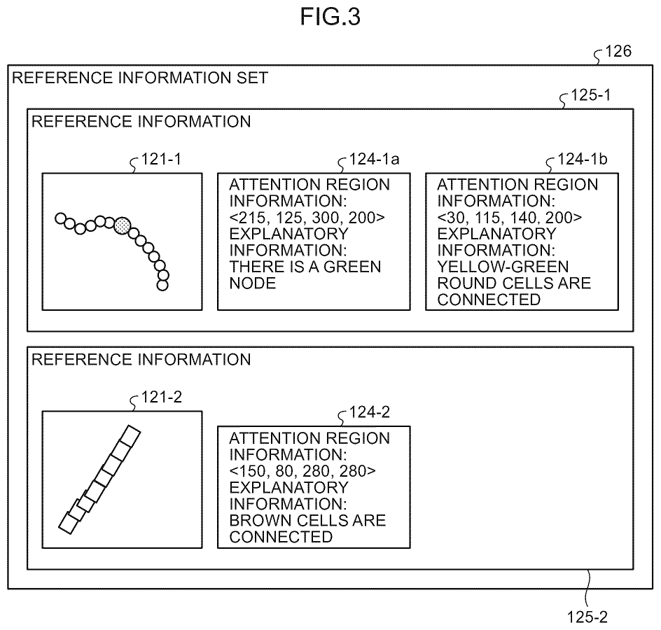

FIG. 3 is a diagram illustrating a specific example of the reference information set 126 according to the first embodiment. In the example of FIG. 3, the reference information set 126 includes pieces of reference information 125-1 and 125-2.

The reference information 125-1 includes a reference image 121-1 and attention region information pairs 124-1a and 124-1b. The reference information 125-2 includes a reference image 121-2 and an attention region information pair 124-2.

In the example of FIG. 3, each attention region information included in each attention region information pair is expressed by a set of x and y coordinates for each of the lower left vertex and the upper right vertex of the rectangle. For instance, the attention region information <215, 125, 300, 200> included in the attention region information pair 124-1a represents that the coordinates of the upper left vertex of the rectangle indicating the attention region information are (215, 125) and the coordinates of the lower right vertex are (300, 200).

Returning to FIG. 1, the recognition unit 130 recognizes the input information based on the reference information 125 described above. The recognition unit 130 includes a candidate acquisition unit 131, an extraction unit 132, a selection unit 133, and the execution unit 134.

The candidate acquisition unit 131 acquires a plurality of partial region candidates from the recognition target image.

The extraction unit 132 extracts the feature (feature of the attention region information 122 and feature of the explanatory information 123) regarding the attention region of the reference image 121 based on the reference image 121, the attention region information 122, and the explanatory information 123 described above.

The selection unit 133 extracts a feature from the candidate of each partial region acquired by the candidate acquisition unit 131 and compares the feature with the feature obtained by the extraction unit 132. Then, the selection unit 133 selects a partial region of the recognition target image based on a feature similarity. For example, the selection unit 133 selects a partial region of the recognition target image having a higher similarity to the attention region of the reference image 121.

The execution unit 134 executes the image recognition task based on the partial region selected by the selection unit 133 and the attention region feature extracted by the extraction unit 132.

The processing of the image recognition task may include the following.
Estimating an image category
Estimating an object region in an image
Counting objects in an image
Dividing a region in an image
Generating an explanatory sentence related to an image
Generating an image
Generating a response sentence to a question related to an image

When an input text is acquired by the input text acquisition unit 112, the input text may be input to the execution unit 134 and used for the processing of the image recognition task. Alternatively, for example, the recognition target image or the reference image 121 may be input to the execution unit 134 and used for the processing of the image recognition task.

The output unit 140 generates output information (for example, output text) based on the recognition result obtained by the execution unit 134.

As a specific example, an image recognition task of determining the reference image 121 belonging to the same image category as the recognition target image from among the plural reference images 121 will be described.

The extraction unit 132 acquires the attention region from the reference image 121 based on the attention region information 122, extracts the feature of the attention region from the attention region, and extracts the feature of the explanatory information from the explanatory information 123. At this time, a deep learning model (hereinafter, referred to as a “feature extraction model”) capable of projecting the attention region and the text of the explanatory information on the same feature space is used for the feature extraction. Specifically, a method using a neural network such as contrastive language-image training (CLIP) can be considered, which is described in, for example, “Alec Radford, Jong Wook Kim, Chris Hallacy, Aditya Ramesh, Gabriel Goh, Sandhini Agarwal, Girish Sastry, Amanda Askell, Pamela Mishkin, Jack Clark, Gretchen Krueger, Ilya Sutskever, ”Learning Transferable Visual Models From Natural Language Supervision,“ Proceedings of the 38th International Conference on Machine Learning, 2021”.

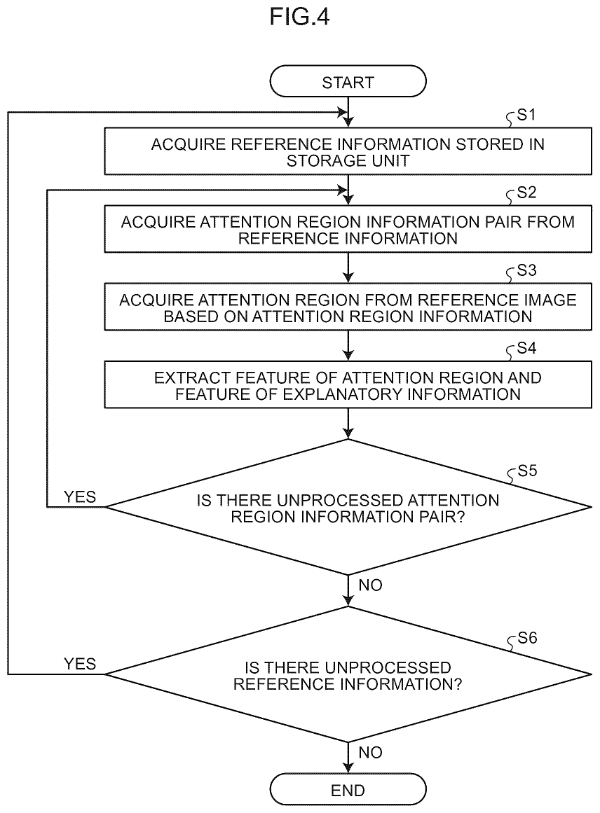

FIG. 4 is a flowchart illustrating a processing example of the extraction unit 132 according to the first embodiment. First, the extraction unit 132 acquires the reference information 125 (reference image 121, attention region information 122, and explanatory information 123) stored in the storage unit 120 (step S1).

The extraction unit 132 acquires the attention region information pair 124 (the attention region information 122 and the explanatory information 123) from the reference information 125 acquired in step S1 (step S2).

The extraction unit 132 acquires the attention region from the reference image 121 based on the attention region information 122 (step S3).

The extraction unit 132 extracts the feature of the attention region and the feature of the explanatory information (step S4).

The extraction unit 132 determines whether there is an unprocessed attention region information pair 124. In response to determining that there is an unprocessed attention region information pair 124 (step S5, Yes), the process returns the process to step S2. In response to determining that there is no unprocessed attention region information pair 124 (step S5, No), the process proceeds to step S6.

In step S6, the extraction unit 132 determines whether there is unprocessed reference information 125. In response to determining that there is unprocessed reference information 125 (step S6, Yes), the process returns to step S1. When there is no unprocessed reference information 125 (step S6, No), the process ends.

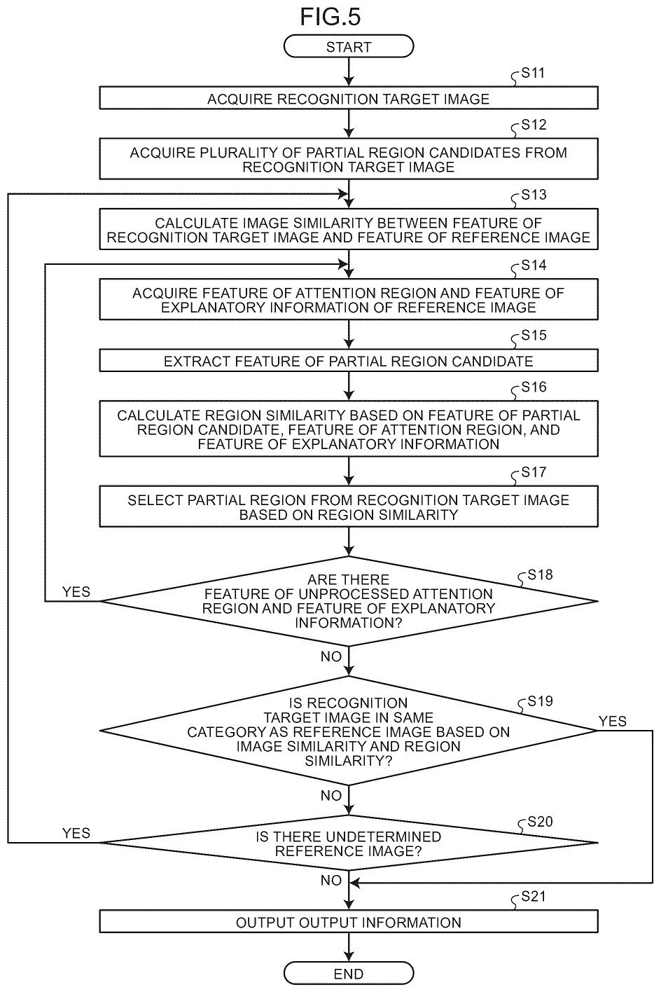

FIG. 5 is a flowchart illustrating a processing example of a recognition target image according to the first embodiment. First, the recognition target data acquisition unit 111 acquires an image as recognition target data from the input information (step S11).

The candidate acquisition unit 131 acquires a plurality of partial region candidates from the recognition target image (step S12). The candidate of the partial region is a preset region. The candidate of the partial region may be a region obtained with a deep learning model for estimating a region where an object exists in an image, such as a region proposal network (RPN) described in, for example, “Shaoqing Ren, Kaiming He, Ross Girshick, Jian Sun,” Faster R-CNN: Towards Real-Time Object Detection with Region Proposal Networks,“ Advances in Neural Information Processing Systems 28, 2015”.

Subsequently, the selection unit 133 calculates the feature of the recognition target image and the feature of the reference image 121 by using the feature extraction model (step S13). The selection unit 133 also calculates an image similarity (first similarity) based on the feature of the recognition target image and the feature of the reference image 121 (step S13). Note that the calculation of the image similarity may be executed by the execution unit 134.

The selection unit 133 acquires the feature of the attention region of the reference image 121 having the higher image-similarity calculated in step S13 and the feature of the explanatory information 123 (step S14). Note that the feature of the attention region of the reference image 121 and the feature of the explanatory information 123 are extracted by the extraction unit 132 by the processing of FIG. 4 described above.

The selection unit 133 extracts the features of the partial region candidates acquired in step S12 by using the feature extraction model (step S15).

The selection unit 133 calculates a region similarity (second similarity) based on the feature of the partial region candidate extracted in step S15, the feature of the attention region acquired in step S14, and the feature of the explanatory information 123 (step S16). Note that the calculation of the region similarity may be executed by the execution unit 134.

The selection unit 133 selects, for example, a partial region most similar to the attention region of the reference image 121 from among partial region candidates of the recognition target image based on the region similarity calculated in step S16 (step S17).

Specifically, the selection unit 133 selects a partial region candidate having a larger sum, product, minimum value, or maximum value of the similarity between the feature of the partial region candidate, the feature of the attention region, and the feature of the explanatory information 123. For the similarity, an index representing the closeness between vectors representing two features, such as a cosine similarity and Euclidean distance, can be used.

Subsequently, the selection unit 133 determines whether there are a feature of the unprocessed attention region and a feature of the explanatory information. In response to determining that there are the feature of the unprocessed attention region and the feature of the explanatory information (step S18, Yes), the process returns to step S14. In response to determining that the feature of the unprocessed attention region and the feature of the explanatory information are not present (step S18, No), the process proceeds to step S19.

In step S19, the execution unit 134 determines whether the recognition target image belongs to the same category as the reference image 121, based on the image similarity calculated in step S13 and the region similarity of the partial region selected in step S17. Specifically, for example, the execution unit 134 determines that the recognition target image and the reference image belong to the same image category in a case where a sum, a product, a minimum value, or a maximum value of the image similarity and the region similarity is equal to or larger than a preset threshold value.

In response to determining that the recognition target image does not belong to the same category as the reference image 121 (step S19, No), the process proceeds to step S20. In step S20, the selection unit 133 determines whether there is an undetermined reference image 121. In response to determining that there is undetermined reference image 121 (step S20, Yes), the process returns to step S13. In response to determining that there is no undetermined reference image 121 (step S20, No), the process proceeds to step S21.

Also, in response to determining that the recognition target image belongs to the same category as the reference image 121 (step S19, Yes), the process proceeds to step S21.

In step S21, the output unit 140 outputs information based on the determination result of step S19. The output information may include a text indicating a category that has been determined to belong to the same category in step S19. Alternatively, for example, in a case where all the reference images 121 fall below the threshold value, the output information may include a text indicating that there is no reference image 121 belonging to the same image category as the recognition target image.

Note that the execution unit 134 may be provided with plural recognition tasks. In such a case, the execution unit 134 selects, based on the input text, a recognition task to be executed from among the plural recognition tasks.

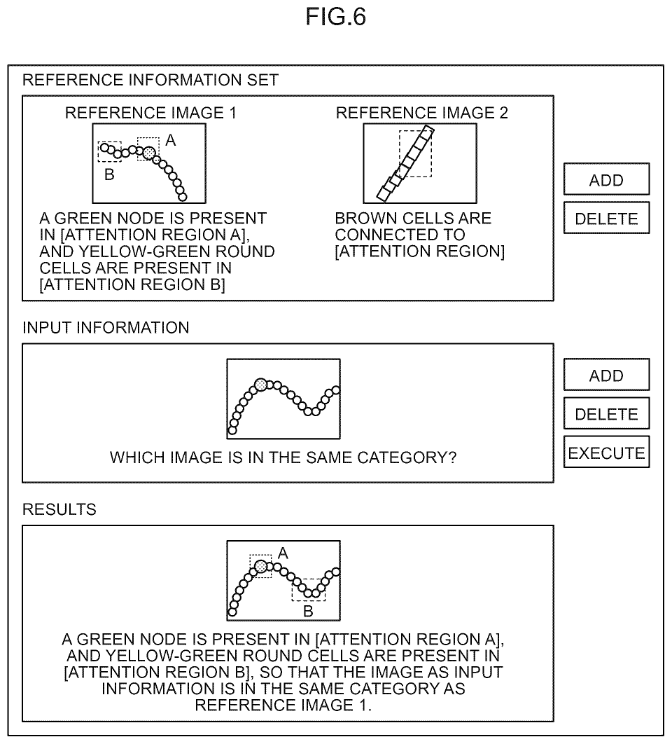

FIG. 6 is a diagram illustrating a display example of output information according to the first embodiment. FIG. 6 illustrates a display example of the output information output by the output unit 140. In the display example of FIG. 6, there are a display region indicating the reference information set 126, a display region indicating the input information (corresponding to the input information received by the reception unit 110), and a display region indicating the result (corresponding to the recognition result by the execution unit 134).

In the display region indicating reference information set 126, a figure (in the display example of FIG. 6, attention regions A and B of reference image 1 are illustrated) representing the attention region of each reference image 121 is superimposed on each reference image 121 and displayed. In the display region indicating the reference information set 126, an explanatory sentence (corresponding to the explanatory information 123 in FIG. 2) of the attention region of each reference image 121 is displayed.

Additionally, the reference information 125 included in the reference information set 126 can be added or deleted according to the input of the operation by the user. For example, the reception unit 110 receives the reference information 125 to be added in response to an operation input indicating addition of the reference information 125. The output unit 140 may further display an update button or the like in the display region indicating the reference information set 126 so that the reference information 125 can be edited (updated) more easily.

In the display region indicating the input information, the recognition target image and the input text are displayed.

In the display region indicating the result, a recognition result image and a text indicating the recognition result are displayed. In the recognition target image, a figure (in the display example of FIG. 6, attention regions A and B) representing a partial region of the recognition target image is superimposed and displayed.

As described above, in the information processing device 10 according to the first embodiment, the reception unit 110 receives the input of the input information including the recognition target data (in the first embodiment, an image). The recognition unit 130 executes a recognition task of recognizing recognition target data based on the reference information 125 including reference data (in the first embodiment, the reference image 121), one or more pieces of attention region information 122 indicating the entire or the partial attention region of the reference data, and the explanatory information 123 related to the attention region. Then, the output unit 140 outputs output information including recognition result by the recognition task.

According to the first embodiment described above, the recognition accuracy of the recognition target data can be further improved. Specifically, according to the information processing device 10 of the first embodiment, more detailed reference information is given by the attention region information 122 and the explanatory information 123 (for example, shape, color, and the like) as the reference information 125, so that higher performance recognition can be performed. In the related art, only the attention region (for example, a partial region of the image) as reference data is input to the recognition system, and detailed information about the feature of the attention region cannot be given. Therefore, there is a problem that the reference data cannot be effectively used and the recognition performance is insufficient.

### Second embodiment

Next, the second embodiment will be described. In the description of the second embodiment, the description similar to that of the first embodiment will be omitted, and the description different from that of the first embodiment will be described.

### Example of Functional Configuration

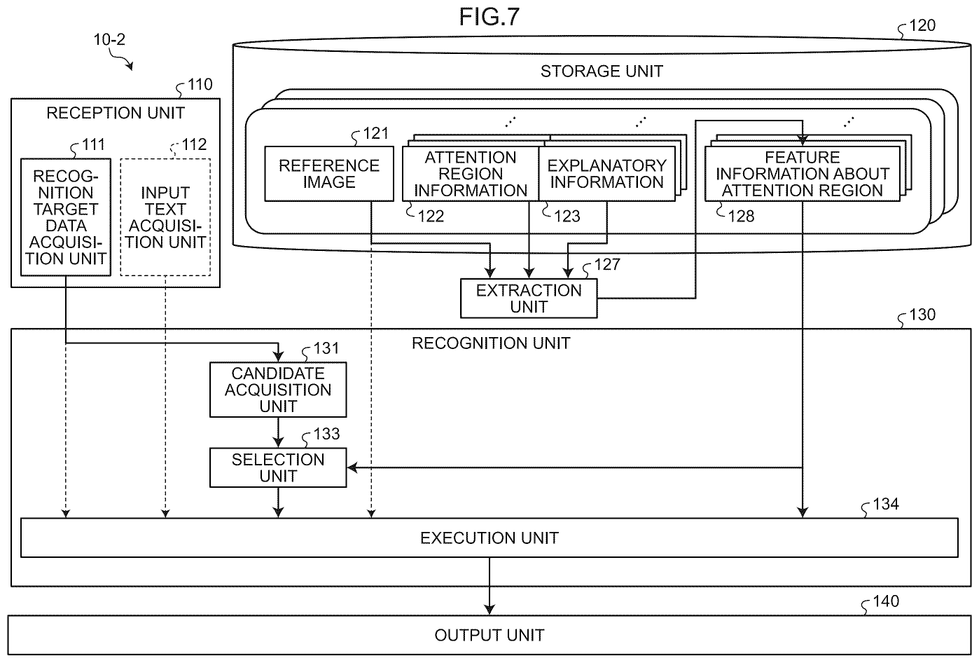

FIG. 7 is a diagram illustrating an example of a functional configuration of an information processing device 10-2 according to the second embodiment. The information processing device 10-2 according to the second embodiment includes a reception unit 110, a storage unit 120, an extraction unit 127, a recognition unit 130, and an output unit 140. Note that the storage unit 120 is implemented by a nonvolatile memory or another storage device, and may be included in the information processing device 10 as illustrated in the drawing, or may be implemented by a storage device for storing data on a cloud and provided outside the information processing device 10.

In the second embodiment, a function corresponding to the extraction unit 132 (FIG. 1) of the first embodiment is provided outside the recognition unit 130 as the extraction unit 127.

The extraction unit 127 extracts the feature of the attention region based on the reference image 121, the attention region information 122, and the explanatory information 123 stored in the storage unit 120 to store the feature as feature information 128 of the attention region in the storage unit 120.

As in the second embodiment, the extraction unit 127 and the recognition unit 130 may be separated, and the extraction processing and the recognition processing may be executed by, for example, two different processors. As a result, for example, the load due to the extraction processing and the load due to the recognition processing can be distributed.

According to the second embodiment, the feature information 128 of the attention region indicated by the attention region information 122 can be stored in the storage unit 120 in advance. As a result, there is no need to extract a feature every time a user's input is received, so that the recognition processing speed can be improved.

### Third embodiment

Next, the third embodiment will be described. In the description of the third embodiment, the description similar to that of the first embodiment will be omitted, and the description different from that of the first embodiment will be described. In the third embodiment, a case where the recognition target data is a time series image will be described.

### Example of Functional Configuration

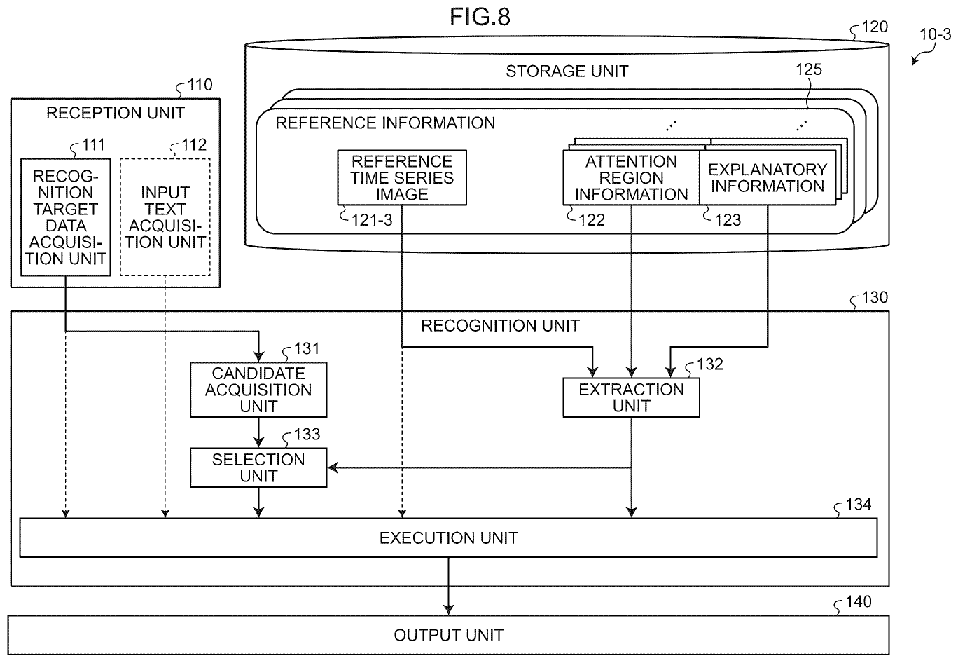

FIG. 8 is a diagram illustrating an example of a functional configuration of an information processing device 10-3 according to the third embodiment. The information processing device 10 according to the first embodiment includes a reception unit 110, a storage unit 120, a recognition unit 130, and an output unit 140.

In the third embodiment, reference information 125 includes a reference time series image 121-3. In the following description, differences from the first embodiment will be mainly described.

The reception unit 110 acquires input information. The input information is data input by the user to the information processing device 10-3, and includes the time series image to be recognized. Note that the input information may include the above-described input text.

The recognition target data acquisition unit 111 acquires the time series image as recognition target data from the input information.

The input text acquisition unit 112 acquires the above-described input text from the input information. Specifically, in a case where plural recognition tasks can be executed, the recognition task to be executed may be designated by the input text. Moreover, for example, in a case where the recognition task generates a response sentence to the user's question on the time series image to be recognized, the input text may be a question sentence indicating the content of the question.

The storage unit 120 stores the reference time series image 121-3, the attention region information 122, and the explanatory information 123. Note that the storage unit 120 is implemented by a nonvolatile memory or another storage device, and may be included in the information processing device 10 as illustrated in the drawing, or may be implemented by a storage device for storing data on a cloud and provided outside the information processing device 10.

The reference time series image 121-3 indicates a time series image to be a reference for recognition of the time series image to be recognized.

The attention region information 122 represents the entire or the partial attention region of the reference time series image 121-3. The attention region of the reference time series image 121-3 refers to the entire or the partial region that is useful for recognition of the reference time series image 121-3. The “region” covers a planar range of one or more pixels and a time range of one or more frames in the time series image. The range is represented by any of a rectangle, a polygon, a circle, an ellipse, a point, and a set of a plurality of points for the planar range. The time range is represented by a frame number, a frame number of a start point and an end point, or a set of a plurality of frame numbers.

The explanatory information 123 is information indicating description regarding the attention region information 122. For example, the explanatory information 123 is an optional text describing the attention region indicated by the attention region information 122. The explanatory information 123 may be information about appearance such as a shape, a size, a color, a texture, and a pattern in the attention region. The explanatory information 123 may be information indicating a motion and a state of movement of the object. The explanatory information 123 may be information indicating a function, a property, and the like of a target included in the attention region. The explanatory information 123 may be information indicating an appellation, a name, and the like of the attention region.

The recognition unit 130 recognizes the input information based on the reference information 125 described above. The recognition unit 130 includes a candidate acquisition unit 131, an extraction unit 132, a selection unit 133, and the execution unit 134.

The candidate acquisition unit 131 acquires a plurality of partial region candidates from the time series image to be recognized.

The extraction unit 132 extracts features (feature of the attention region information 122 and feature of the explanatory information 123) regarding the attention region of the reference time series image 121-3 based on the reference time series image 121-3, the attention region information 122, and the explanatory information 123 described above.

The selection unit 133 extracts a feature from the candidate of each partial region acquired by the candidate acquisition unit 131 and compares the feature with the feature obtained by the extraction unit 132. Then, the selection unit 133 selects a partial region of the time series image to be recognized based on the feature similarity. For example, the selection unit 133 selects a partial region of the time series image to be recognized having a higher similarity to the attention region of the reference time series image 121-3.

The execution unit 134 executes the recognition task of the time series image based on the partial region selected by the selection unit 133 and the attention region feature extracted by the extraction unit 132.

The processing of the recognition task of the time series image may include the following.
Estimating a time series image category
Estimating an object region in a time series image
Counting objects in a time series image
Dividing a region in a time series image
Generating an explanatory sentence related to a time series image
Generating a response sentence to a question about a time series image
Estimating a time zone that a specific object is present in a time series image
Estimating category of operation being performed in a time series image
Generating a time series image
Estimating a time zone that a specific operation is performed in a time series image

Note that, in a case where the input text is acquired by the input text acquisition unit 112, the input text may be input to the execution unit 134, and may be used for the processing of the recognition task of the time series image. Moreover, for example, the time series image to be recognized or the reference time series image 121-3 may be input to the execution unit 134, and the time series image to be recognized or the reference time series image 121-3 may be used for processing the recognition task of the time series image. The output unit 140 generates output information (for example, output text) based on the recognition result obtained by the execution unit 134.

As described above, according to the third embodiment, even in a case where the recognition target data is a time series image, the recognition accuracy can be further improved.

### Fourth Embodiment

Next, the fourth embodiment will be described. In the description of the fourth embodiment, the description similar to that of the first embodiment will be omitted, and the description different from that of the first embodiment will be described. In the fourth embodiment, a case where the recognition target data is three-dimensional data will be described.

### Example of functional configuration

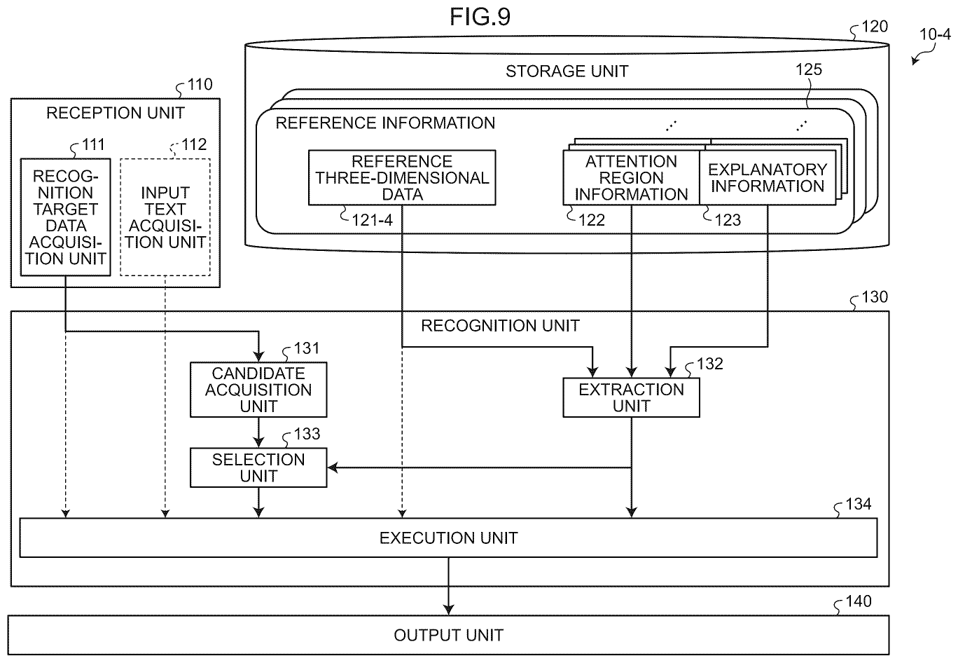

FIG. 9 is a diagram illustrating an example of a functional configuration of an information processing device 10-4 according to the fourth embodiment. The information processing device 10 according to the first embodiment includes a reception unit 110, a storage unit 120, a recognition unit 130, and an output unit 140.

In the fourth embodiment, the reference information 125 includes reference three-dimensional data 121-4. In the following description, differences from the first embodiment will be mainly described.

The reception unit 110 acquires input information. The input information is data input by the user to the information processing device 10-4, and includes three-dimensional data to be recognized. Note that the input information may include the above-described input text.

The recognition target data acquisition unit 111 acquires three-dimensional data as recognition target data from the input information.

The input text acquisition unit 112 acquires the above-described input text from the input information. Specifically, in a case where plural recognition tasks can be executed, the recognition task to be executed may be designated by the input text. Moreover, for example, in a case where the recognition task generates a response sentence to a user's question on three-dimensional data to be recognized, the input text may be a question sentence indicating the content of the question.

The storage unit 120 stores the reference three-dimensional data 121-4, the attention region information 122, and the explanatory information 123. Note that the storage unit 120 is implemented by a nonvolatile memory or another storage device, and may be included in the information processing device 10 as illustrated in the drawing, or may be implemented by a storage device for storing data on a cloud and provided outside the information processing device 10.

The reference three-dimensional data 121-4 indicates three-dimensional data serving as a reference for recognition of the three-dimensional data to be recognized.

The attention region information 122 represents the entire or the partial attention region of the reference three-dimensional data 121-4. The attention region of the reference three-dimensional data 121-4 indicates the entire or the partial region that is useful for recognition of the reference three-dimensional data 121-4. The “region” covers a range of one or more points in the three-dimensional data. The range is represented by any of a three-dimensional rectangle, a polyhedron, a circle, an ellipsoid, a point, and a set of a plurality of points.

The explanatory information 123 is information indicating description regarding the attention region information 122. For example, the explanatory information 123 is an optional text describing the attention region indicated by the attention region information 122. For example, the explanatory information 123 may be information indicating appearance such as shape, size, color, texture, and pattern in the attention region. The explanatory information 123 may be information indicating a function, a property, and the like of a target included in the attention region. The explanatory information 123 may be information indicating an appellation, a name, and the like of the attention region.

The recognition unit 130 recognizes the input information based on the reference information 125 described above. The recognition unit 130 includes a candidate acquisition unit 131, an extraction unit 132, a selection unit 133, and the execution unit 134.

The candidate acquisition unit 131 acquires plural partial region candidates from the three-dimensional data to be recognized.

Based on the reference three-dimensional data 121-4, the attention region information 122, and the explanatory information 123 described above, the extraction unit 132 extracts features (feature of the attention region information 122 and feature of the explanatory information 123) related to the attention region of the reference three-dimensional data 121-4.

The selection unit 133 extracts a feature from the candidate of each partial region acquired by the candidate acquisition unit 131 and compares the feature with the feature obtained by the extraction unit 132. Then, the selection unit 133 selects a partial region of the three-dimensional data to be recognized based on the feature similarity. For example, the selection unit 133 selects a partial region of the three-dimensional data to be recognized having a higher similarity to the attention region of the reference three-dimensional data 121-4.

The execution unit 134 executes the recognition task of the three-dimensional data based on the partial region selected by the selection unit 133 and the attention region feature extracted by the extraction unit 132.

The processing of the three-dimensional data recognition task may include the following.
Estimating a three-dimensional data category
Estimating an object region in a three-dimensional data
Counting objects in a three-dimensional data
Dividing a region in a three-dimensional data
Generating an explanatory sentence related to a three-dimensional data
Generating a three-dimensional data
Generating a response sentence to a question about a three-dimensional data

Note that, in a case where the input text is acquired by the input text acquisition unit 112, the input text may be input to the execution unit 134, and may be used for the processing of the recognition task of the three-dimensional data. Moreover, for example, the three-dimensional data to be recognized or the reference three-dimensional data 121-4 may be input to the execution unit 134, and the three-dimensional data to be recognized or the reference three-dimensional data 121-4 may be used for the processing of the recognition task of the three-dimensional data.

The output unit 140 generates output information (for example, output text) based on the recognition result obtained by the execution unit 134.

As described above, according to the fourth embodiment, even in a case where the recognition target data is three-dimensional data, the recognition accuracy can be further improved.

### Fifth Embodiment

Next, the fifth embodiment will be described. In the description of the fifth embodiment, the description similar to that of the first embodiment will be omitted, and the description different from that of the first embodiment will be described. In the fifth embodiment, a case where recognition target data is an audio signal will be described.

### Example of Functional Configuration

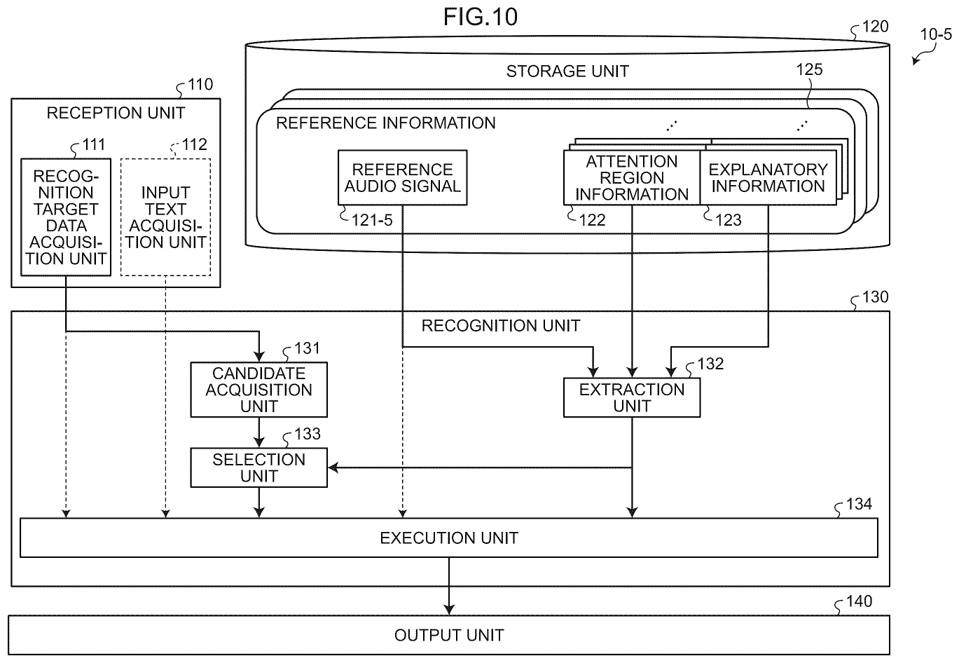

FIG. 10 is a diagram illustrating an example of a functional configuration of an information processing device 10-5 according to the fifth embodiment. The information processing device 10 according to the first embodiment includes a reception unit 110, a storage unit 120, a recognition unit 130, and an output unit 140.

In the fifth embodiment, the reference information 125 includes a reference audio signal 121-5. In the following description, differences from the first embodiment will be mainly described.

The reception unit 110 acquires input information. The input information is data input by the user to the information processing device 10-5, and includes an audio signal to be recognized. Note that the input information may include the above-described input text.

The recognition target data acquisition unit 111 acquires an audio signal as recognition target data from the input information.

The input text acquisition unit 112 acquires the above-described input text from the input information. Specifically, in a case where plural recognition tasks can be executed, the recognition task to be executed may be designated by the input text. Moreover, for example, in a case where the recognition task generates a response sentence to a user's question on the audio signal to be recognized, the input text may be a question sentence indicating the content of the question.

The storage unit 120 stores the reference audio signal 121-5, the attention region information 122, and the explanatory information 123. Note that the storage unit 120 is implemented by a nonvolatile memory or another storage device, and may be included in the information processing device 10 as illustrated in the drawing, or may be implemented by a storage device for storing data on a cloud and provided outside the information processing device 10.

The reference audio signal 121-5 indicates an audio signal serving as a reference for recognition of the audio signal to be recognized.

The attention region information 122 indicates the entire or the partial attention region of the reference audio signal 121-5. The attention region of the reference audio signal 121-5 indicates the entire or the partial region useful for recognition of the reference audio signal 121-5. The “region” covers a range of one or more samples, a range of a specific frequency, or a range of a specific amplitude in the audio signal. In addition, the range is represented by a sample number, a set of a start number and an end number of a sample, a set of a plurality of sample numbers, a frequency value, a set of a minimum value and a maximum value of a frequency, a set of a plurality of frequency values, an amplitude value, a set of a minimum value and a maximum value of an amplitude, or a set of a plurality of amplitude values.

The explanatory information 123 is information indicating description regarding the attention region information 122. For example, the explanatory information 123 is an optional text describing the attention region indicated by the attention region information 122. For example, the explanatory information 123 is information about a signal waveform such as amplitude and a frequency of the audio signal in the attention region. The explanatory information 123 may be information about the content of the audio signal such as the utterance content and the type of the audio. The explanatory information 123 may be information indicating an appellation, a name, and the like of the attention region.

The recognition unit 130 recognizes the input information based on the reference information 125 described above. The recognition unit 130 includes a candidate acquisition unit 131, an extraction unit 132, a selection unit 133, and the execution unit 134.

The candidate acquisition unit 131 acquires plural partial region candidates from an audio signal to be recognized.

The extraction unit 132 extracts features (feature of the attention region information 122 and feature of the explanatory information 123) related to the attention region of the reference audio signal 121-5 based on the reference audio signal 121-5, the attention region information 122, and the explanatory information 123 described above.

The selection unit 133 extracts a feature from the candidate of each partial region acquired by the candidate acquisition unit 131 and compares the feature with the feature obtained by the extraction unit 132. Then, the selection unit 133 selects a partial region of the audio signal to be recognized based on the feature similarity. For example, the selection unit 133 selects a partial region of the audio signal of the recognition target having a higher similarity to the attention region of the reference audio signal 121-5.

The execution unit 134 executes the recognition task of the audio signal based on the partial region selected by the selection unit 133 and the attention region feature extracted by the extraction unit 132.

The processing of the audio signal recognition task may include the following.
Estimating a category of an audio signal
Recognizing an utterance in an audio signal
Estimating a time zone that a specific voice occurs in an audio signal
Counting the number of times that a specific voice occurs in an audio signal
Estimating the frequency of an audio signal, in which a specific feature appears
Estimating the amplitude of an audio signal, in which a specific feature appears
Generating an audio signal

Note that, in a case where the input text is acquired by the input text acquisition unit 112, the input text may be input to the execution unit 134, and may be used for the processing of the recognition task of the audio signal. Moreover, for example, the audio signal to be recognized or the reference audio signal 121-5 may be input to the execution unit 134, and the audio signal to be recognized or the reference audio signal 121-5 may be used for processing the recognition task of the audio signal.

The output unit 140 generates output information (for example, output text) based on the recognition result obtained by the execution unit 134.

As described above, according to the fourth embodiment, even in a case where the recognition target data is an audio signal, the recognition accuracy can be further improved.

Note that, in the first to fifth embodiments described above, a case where the recognition target data is an image, a time series image, three-dimensional data, or an audio signal is described as an example, but the configurations of the information processing devices 10 to 10-5 of the first to fifth embodiments may be implemented by one information processing device.

Thus, recognition target data including at least one of the first image, the first time series image, the first three-dimensional data, and the first audio signal may be set as a processing target. In a case where the recognition target data includes the first image, the reference data includes the second image. In a case where the recognition target data includes the first time series image, the reference data includes the second time series image. In a case where the recognition target data includes the first three-dimensional data, the reference data includes the second three-dimensional data. In a case where the recognition target data includes the first audio signal, the reference data includes the second audio signal.

Finally, an example of a hardware configuration of the information processing device 10 (10-2 to 10-5) according to the first to fifth embodiments will be described.

### Example of Hardware Configuration

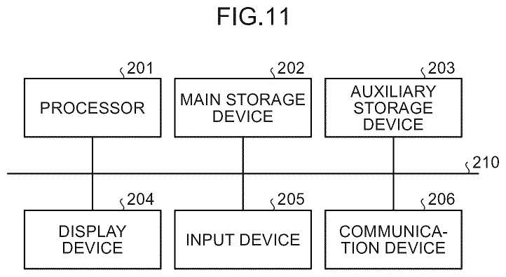

FIG. 11 is a diagram illustrating an example of a device configuration of the information processing device 10 (10-2 to 10-5) according to the first to fifth embodiments. The information processing device 10 (10-2 to 10-5) according to the first to fifth embodiments includes a processor 201, a main storage device 202, an auxiliary storage device 203, a display device 204, an input device 205, and a communication device 206. The processor 201, the main storage device 202, the auxiliary storage device 203, the display device 204, the input device 205, and the communication device 206 are connected via a bus 210.

Note that the information processing device 10 (10-2 to 10-5) may not include part of the above configuration. For example, in a case where the information processing device 10 (10-2 to 10-5) can use an input function and a display function of an external device, the information processing device 10 (10-2 to 10-5) may not include the display device 204 and the input device 205.

The processor 201 executes a computer program read from the auxiliary storage device 203 to the main storage device 202. The main storage device 202 is a memory such as a ROM and a RAM. The auxiliary storage device 203 is a hard disk drive (HDD), a memory card, or the like.

The display device 204 is, for example, a liquid crystal display or the like. The input device 205 is an interface for operating the information processing device 10 (10-2 to 10-5). Note that the display device 204 and the input device 205 may be implemented by a touch panel or the like having the display function and the input function. The communication device 206 is an interface for communicating with other devices.

The computer program to be executed by the information processing device 10 (10-2 to 10-5) may be recorded as a file in an installable format or an executable format in a computer-readable storage medium such as a memory card, a hard disk, a CD-RW, a CD-ROM, a CD-R, a DVD-RAM, and a DVD-R, and is provided as a computer program product.

The computer program to be executed by the information processing device 10 (10-2 to 10-5) may be stored in a computer connected to a network such as the Internet and provided by being downloaded via the network.

The computer program to be executed by the information processing device 10 (10-2 to 10-5) may be provided via a network such as the Internet without being downloaded. Specifically, the information processing may be executed by a so-called application service provider (ASP) type service that implements a processing function only by an execution instruction and result acquisition without transferring the program from the server computer.

The computer program to be executed by the information processing device 10 (10-2 to 10-5) may be provided by being incorporated in a ROM or the like in advance.

The computer program to be executed by the information processing device 10 (10-2 to 10-5) may have a module configuration including functions that can be implemented by the program among the above-described functional configurations. As actual hardware, the processor 201 reads a program from a storage medium and executes the program, whereby the functional blocks are loaded on the main storage device 202. Thus, the functional blocks are generated on the main storage device 202.

Note that some of or all the above-described functions may not be implemented by software but may be implemented by hardware such as an integrated circuit (IC).

In addition, each function may be implemented by using a plurality of processors 201. In this case, each processor 201 may implement one of the functions or may implement two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising
a hardware processor connected to a memory and configured to:
receive an input of input information including recognition target data;
execute one or more recognition tasks, each being a task of recognizing the recognition target data based on reference information including reference data, one or more pieces of attention region information indicating an entire or a partial attention region of the reference data, and explanatory information about the attention region; and
output information including recognition result obtained by executing the one or more recognition tasks.

2. The information processing device according to claim 1, wherein
the recognition target data includes at least one of a first image, a first time series image, first three-dimensional data, or a first audio signal,
the reference data includes a second image in a case where the recognition target data includes the first image,
the reference data includes a second time series image in a case where the recognition target data includes the first time series image,
the reference data includes second three-dimensional data in a case where the recognition target data includes the first three-dimensional data, and
the reference data includes a second audio signal in a case where the recognition target data includes the first audio signal.

3. The information processing device according to claim 1, wherein the explanatory information is an optional text describing an attention region indicated by the attention region information.

4. The information processing device according to claim 1, wherein
the hardware processor is further configured to:
calculate a first similarity based on a feature of recognition target data and a feature of reference data,
select the reference data for which the first similarity is higher, and
calculate a second similarity between an attention region of the selected reference data and a partial region of the recognition target data, the second similarity being calculated based on a feature of an attention region indicated by the attention region information of the selected reference data, a feature of the explanatory information of the selected reference data, and a feature of the partial region of the recognition target data, and
the one or more recognition tasks each recognize the recognition target data based on the first similarity and the second similarity.

5. The information processing device according to claim 1, wherein
the hardware processor is further configured to execute two or more of the recognition tasks, and
the input information further includes information designating a recognition task to be executed among the two or more of the recognition tasks.

6. The information processing device according to claim 1, wherein
the hardware processor is further configured to generate a response to a question on the recognition target data, and
the input information further includes a text indicating the question.

7. The information processing device according to claim 1, wherein the hardware processor is further configured to receive an input of the reference information.

8. The information processing device according to claim 1, wherein the hardware processor is further configured to extract feature information about an attention region indicated by the attention region information, the feature information being extracted based on the reference data, the attention region information, and the explanatory information.

9. An information processing method implemented by a computer, the method comprising:
receiving an input of input information including recognition target data;
executing one or more recognition tasks, each being a task of recognizing the recognition target data based on reference information including reference data, one or more pieces of attention region information indicating an entire or a partial attention region of the reference data, and explanatory information about the attention region; and
outputting information including recognition result obtained by executing the one or more recognition tasks.

10. A computer program product comprising a non-transitory computer readable recording medium on which a computer program executable by a computer is stored, the computer program instructing the computer to perform processing, the processing including:
receiving an input of input information including recognition target data;
executing one or more recognition tasks, each being a task of recognizing the recognition target data based on reference information including reference data, one or more pieces of attention region information indicating an entire or a partial attention region of the reference data, and explanatory information about the attention region; and
outputting information including recognition result obtained by executing the one or more recognition tasks.
